(19) United States
(12) Patent Application Publication
(10) Pub. No.: US 2025/0025885 A1
(43) Pub. Date: Jan. 23, 2025

(54) LABORATORY BALL MILL

(71) Applicant: Retsch GmbH, Haan (DE)

(72) Inventor: Zilan Orhan, Hilden (DE)

(73) Assignee: Retsch GmbH, Haan (DE)

(21) Appl. No.: 18/686,601

(22) PCT Filed: Aug. 29, 2022
(86) PCT No.: PCT/EP2022/073910

§ 371 Date: Feb. 26, 2024

(30) Foreign Application Priority Data
Aug. 30, 2021 (DE) 10 2021 122 355.5
Oct. 11, 2021 (DE) 10 2021 126 268.2
Oct. 29, 2021 (DE) 10 2021 128 267.5

(51) Int. Cl. B02C 17/24; B02C 17/04; B02C 17/18

(52) U.S. Cl. CPC B02C 17/24; B02C 17/04; B02C 17/1805

(57) ABSTRACT

Shown and described is a laboratory ball mill, in particular a vibrating mill, centrifugal ball mill or planetary ball mill, further in particular a planetary ball mill with a transmission ratio of 1:−1, with at least one grinding bowl holder for at least one grinding bowl arranged on a machine part of the ball mill which is moved during the grinding operation of the ball mill, with a clamping device arranged on the moving machine part for transmitting a clamping force to the grinding bowl and with a coupling device with at least one coupling element, wherein an energy transmission from the stationary machine part to the moving machine part for generating the clamping force is provided via the coupling device. According to the invention, it is provided that the coupling element is coupled to the stationary machine part and to the moving machine part during the grinding operation.

### CROSS-REFERENCE TO RELATED APPLICATIONS

The present application is the U.S. national stage application of international application PCT/EP2022/073910, filed Aug. 29, 2022, which international application was published on Mar. 9, 2023, as International Publication WO 2023/031097 A1. The international application claims priority to German Patent Application No. 102021122355.5, filed Aug. 30, 2021; German Patent Application No. 102021126268.2, filed Oct. 11, 2021; and German Patent Application No. 102021128267.5, filed Oct. 29, 2021. The international application and German applications are hereby incorporated by reference herein in their entireties.

### BACKGROUND

The invention relates to a laboratory ball mill, in particular a vibrating mill, centrifugal ball mill or planetary ball mill, further in particular a planetary ball mill with a transmission ratio of 1:−1, with at least one grinding bowl holder for at least one grinding bowl arranged on a machine part of the ball mill which is moved during the grinding operation of the ball mill, with a clamping device arranged on the moving machine part for transmitting a clamping force and/or a clamping torque to the grinding bowl and/or to the grinding bowl holder and with a coupling device with at least one coupling element, wherein an energy transmission from the stationary machine part to the moving machine part for generating the clamping force is provided via the coupling device.

DE 10 2012 009 987 A1 discloses a laboratory ball mill, in particular a planetary or centrifugal ball mill on a laboratory scale, which can be used in particular for larger grinding vessels on a laboratory scale, i.e. typically 160 ml, 250 ml or even 500 ml, and which permits automatic clamping of a grinding vessel to a grinding vessel holder. In the known laboratory ball mill, a carrier device rotates around a vertical center axis. The known mill has one or more grinding stations around a planetary axis offset parallel to the center axis, which is or are mounted so as to rotate relative to the carrier device. The grinding station has a receiving device or grinding bowl holder for at least one grinding vessel which can be filled with material to be ground and grinding media, in particular grinding balls. During grinding operation, the holding device is guided by the carrier device around the center axis and also rotates—usually in the opposite direction—to the carrier device around the eccentrically mounted planetary axis. There is also a drive for the carrier device and a further drive for the grinding station.

A motorized drive with an eccentric shaft as a coupling element is provided for automatic axial clamping of the grinding vessel in the holding device, i.e. not by manually applying the clamping force. Clamping is achieved by rotating the eccentric shaft, whereby the eccentric shaft acts from below against a grinding bowl base. For this purpose, the eccentric shaft is mounted in a transverse bore in a downwardly extending journal of a clamping base. The journal engages in a matching coaxial bore in a bearing journal of a lower base part of the laboratory mill. The eccentric shaft transmits a change in height to the clamping base via needle bearings. The clamping base lifts a pressure plate in the form of a pressure disc upwards via a spring assembly. The pressure plate in turn lifts the inserted grinding bowl against a pressure yoke above the grinding bowl, which acts as a stop for the grinding bowl lid until all axial gaps have been eliminated from the clamping system. The eccentric shaft is moved beyond its knee point to generate self-locking in the clamped state.

The grinding vessel is tensioned by a motor. For this purpose, the known ball mill has a motor which is fixed to a stationary device housing outside the carrier device. The motor drives a drive shaft which is slotted at its inner end in order to couple to a transverse pin attached transversely to the eccentric shaft when the grinding station comes to rest in a specific insertion and removal position and a correct rotational orientation. If the slot coupling is coupled, the eccentric shaft can be rotated via the motor in order to automatically clamp the grinding vessel axially or automatically release the clamping again. The eccentric shaft therefore only transmits energy from the motorized drive on the stationary machine part to the clamping mechanism on the moving machine part to generate the clamping force when the coupling is engaged.

The advantage of automatic grinding bowl tensioning is that the force generated when unclamping the tensioning mechanism does not have to be applied by the user, but is applied automatically by the tensioning motor. In addition, automatic grinding bowl tensioning leads to greater user comfort and enables the same and therefore reproducible tensioning force to be applied for every tensioning process. Furthermore, safety against incorrect operation can be increased.

The automatic grinding bowl tensioning provided in the known ball mill has a number of disadvantages: Coupling the eccentric shaft to the drive motor requires precise rotational orientation of the grinding station when the mill is at rest. Due to wear and/or contamination, the exact rotational orientation required for coupling may not be achieved, making it difficult to couple the eccentric shaft to the drive shaft of the motor. The self-locking of the eccentric shaft generated during grinding bowl tensioning is intended to ensure that the grinding bowl tension does not loosen unintentionally during grinding operation. However, wear and tear can lead to a change in the position of the knee point, meaning that the safety against unintentional loosening of the grinding bowl tension may no longer be guaranteed. The arrangement and alignment of the motor and eccentric shaft relative to each other for the coupling process also means that the grinder is not very compact. On the other hand, the automatic grinding bowl tensioning in the known mill is a complex design solution. The transmission of energy or force from the motor via the eccentric shaft and the other components of the tensioning device that interact with the eccentric shaft requires a correspondingly solid design of the force transmission elements with a high component weight, so that the components that are also moved during grinding operation experience high centrifugal forces during grinding operation and the bearing and drive load is high.

### SUMMARY

The object of the present invention is to provide a laboratory ball mill of the type mentioned hereinabove, in particular designed as a laboratory vibrating mill, with the possibility of automatic grinding bowl tensioning, in which the grinding bowl tensioning is realized in a structurally simple manner with a light and compact design of the laboratory mill.

In addition, a high level of error-proofing against unintentional loosening of the grinding bowl clamping should be guaranteed.

In particular, the design of the automatic grinding bowl tensioning system should make it possible to tension different grinding bowl geometries, especially grinding bowls with different grinding bowl heights.

The aforementioned tasks are solved by a ball mill with the features of claim 1. Advantageous embodiments of the invention are the subject of the subclaims.

In accordance with the mill known from DE 10 2012 009 987 A1, a coupling element is also provided in the mill according to the invention, via which a drive energy or drive force is transmitted from a stationary machine part of the mill to a machine part moving during grinding operation of the mill to generate the clamping force required for automatic grinding bowl tensioning. In contrast to the known mill, however, the invention provides that the coupling element is (also) mechanically coupled or connected to the stationary machine part and to the moving machine part during grinding operation. Preferably, a permanent, continuous, continuous, uninterrupted, non-destructively separable coupled and/or permanent connection of the coupling element to an energy generation unit, in particular a motorized drive, is provided on and/or on the stationary machine part of the ball mill and to the moving machine part of the ball mill. The design of the automatic grinding bowl tensioning system according to the invention can be realized advantageously, particularly in the case of vibratory mills.

In particular, it is possible to transmit and transfer the force and/or energy required to generate a clamping force and/or a clamping torque via the coupling element independently of the state of movement of the grinding bowl holder, furthermore in particular independently of a specific angular position of a swing arm of a vibrating mill connected to the grinding bowl holder or independently of a specific rotational orientation of a carrier device guiding the grinding bowl holder. A preferably mechanical coupling via the coupling element can be provided both during grinding operation and at a standstill. In particular, the coupling during grinding operation allows a drive force or a drive torque or a drive energy to be passed on or transmitted from the stationary machine part of the mill to the moving machine part via the coupling element, even during grinding operation, in order to generate a clamping force and/or a clamping torque even during grinding operation. In principle, however, the invention also allows a drive force or a drive torque or a drive energy to be transmitted only when the mill is stationary. In this case, a mechanical device, for example a safety clutch, can then be provided in order to maintain a tensioned state of the grinding bowl during grinding operation independently of a transmission of force and/or energy via the coupling element.

In order to generate a clamping force and/or a clamping torque, the clamping device of the mill according to the invention can, for example, have a spindle drive in a manner known per se, whereby a torque transmitted from the coupling device to the clamping device is converted into a translatory adjustment movement of a threaded spindle or push rod.

The coupling device of the laboratory mill according to the invention is set up and designed to transmit energy and/or force or torque from the stationary machine part to the machine part of the mill that is moved during grinding operation. In addition to the coupling element, the coupling device can have further components and devices, for example at least one drive wheel on a drive side of the coupling device assigned to the stationary machine part and/or at least one output wheel on an output side of the coupling device assigned to the moving machine part. A torque generated by the output wheel can then be converted into a transverse movement of a threaded spindle or a push rod using a spindle device. However, it is also possible for components of the coupling device, for example an adjustable piston element, to be adjusted or moved transversely by transmitting drive energy and/or drive force from the coupling element, thereby generating an axial clamping force that can be transmitted directly or indirectly to the grinding bowl.

During grinding operation, relative movements occur between the moving machine part of the ball mill and the stationary machine part. During the grinding operation of vibratory mills, for example, relative movements occur between rockers, on which the grinding bowl holders are provided, relative to the stationary mill structure. Relative movements between moving machine parts of the ball mill and stationary machine parts also occur in centrifugal ball mills or planetary ball mills due to their function. According to the invention, relative movements can preferably be equalized solely via the coupling element. It is particularly preferable for the equalization to take place free of technical joint components as connections between rigid components or sections of the coupling element that can move in a predetermined manner. To compensate for relative movements, however, the coupling element can be designed to be movable in several dimensions, at least in certain areas. In this context, the coupling element can have at least two degrees of freedom of movement in each case orthogonal to the main direction of movement, in relation to the direction of movement of the coupling element when transmitting a clamping torque and/or a clamping force, particularly preferably with the coupling element having free movement orthogonal to the main direction of movement. This is described in more detail below using examples of embodiments of the invention. Thus, the embodiment of the automatic grinding bowl clamping according to the invention can be advantageously realized, in particular in vibrating mills, whereby vibrations occurring during the grinding operation of vibrating mills, to which the grinding bowl holders are fastened, can be compensated relative to a stationary (housing) part of the vibrating mill by the movability of the coupling element. This allows the occurrence of relevant component stresses associated with the risk of component failure to be avoided in a structurally simple manner.

A first and preferred embodiment of the invention relates to the mechanical transmission or forwarding of kinetic energy or kinetic energy from a motorized drive arranged on the stationary machine part to the moving machine part via the coupling element. The clamping force and/or the clamping torque is generated decentrally with the motor drive, which is arranged in a fixed position during grinding operation of the ball mill. The motor power is available through a suitable design of the coupling on the grinding bowl holder. A compact and lightweight design of the components required for automatic grinding bowl tensioning is possible. Due to a lower component mass, a higher load on the moving machine part of the ball mill is possible and/or a lower load on the drive intended for moving the moving machine part during grinding operation. A lower component mass means that the components required for the automatic grinding bowl tensioning on the moving machine part experience lower centrifugal forces during the grinding process and can be designed to be delicate.

Preferably, the coupling element can be a traction means of a particularly form-fit traction means drive for mechanical movement or power transmission. At least one drive wheel or a drive shaft of the motorized drive can be provided on the drive side of the coupling device and thus on the stationary machine part and at least one output wheel or an output shaft on the output side of the coupling device or on the moving machine part for the transmission of movement or force via the coupling element. A drive torque is transmitted from the motorized drive via the drive wheel, in particular a gear wheel or a gear wheel arrangement, and an output torque is transmitted directly or indirectly to the clamping device via the output wheel, in particular a gear wheel or a gear wheel arrangement. The output torque can, for example, be converted into a clamping force required for clamping the grinding bowl using a spindle device.

In the case of a positive-locking traction drive, a chain of a chain transmission or a toothed belt can be provided as a coupling element in order to transmit a torque from a drive shaft of the motorized drive to the traction means or from the traction means to an output shaft on the moving machine part of the ball mill by means of wheels with a corresponding positive-locking profile, in particular toothed wheels. In principle, a traction means of a non-positive traction means drive can also be provided as a coupling element, whereby a tensioning torque is transmitted via a drive belt by frictional forces acting between contact surfaces between belts and pulleys. Alternatively, a thrust chain drive with a thrust means can be provided as a coupling element for the transmission of movement or force.

A particularly preferred embodiment is one in which the coupling element is designed as a ball or bead chain with a core and a plurality of balls or beads attached to the core, preferably at the same distance. Preferably, a bead chain drive is provided, whereby the bead chain is connected on the drive side to a drive wheel for torque transmission from a motor shaft of the motorized drive and on the output side to an output wheel for torque transmission to the tensioning device. The drive wheel and output wheel can have recesses distributed around the circumference and adapted to the balls or bead bodies of the bead chain. The output torque can be converted into a transverse clamping force for clamping the grinding bowl using a spindle device. The bead chain enables hose bends in all spatial directions, so that the position of the output side of the bead chain drive can be easily adapted to the structural conditions inside the ball mill and a compact design of the mill can be realized.

A hose guide for the bead chain can be provided in one or more hoses to support cable forces. The hose guide also fulfils a protective function for the bead chain. Preferably, the hose between a drive wheel and an output wheel of the bead chain drive can extend over the entire length of the bead chain so that the bead chain is wrapped around in every area between the wheels. The drive wheel and/or the output wheel can have a groove-shaped running surface bounded by lateral flanks of the wheel, which contains recesses in the running base. The bead chain is guided between the flanks in the area of the wheels. This ensures support and precise guidance of the bead chain, even adjacent to the hose guide in the wheel and wrap area.

Alternatively, a cardan shaft or an at least partially flexible shaft can be provided as a coupling element for torque transmission in the case of parts moving against each other with the possibility of equalizing relative movements between a stationary machine part and a moving machine part.

The coupling device can have a gear arrangement for torque conversion of a transmitted drive torque, in particular on the output side. A planetary gear can be used, for example, to generate a higher torque on the output side. The gear arrangement can be self-locking, so that a rotary movement is only possible in one direction. If the gearbox arrangement works together with a spindle, a self-locking design of the spindle and the gearbox is possible, so that protection against unintentional release of the grinding bowl tension is guaranteed even if the transmission of force or torque from the coupling element to the output wheel is interrupted, for example if the bead chain is broken.

To limit the transmission of force and/or torque via the coupling element, an overload protection device can be provided, which can be designed in particular as a magnetic slipping clutch and/or arranged in particular on the output side of the coupling element. A sensor device with at least one sensor for detecting a clutch separation in the event of an overload can be provided, in particular for detecting the slipping of a slipping clutch. A control and/or regulation device can then be used to control and/or regulate a motorized drive as a function of a detected clutch separation.

In order to enable energy and/or force or torque In order to enable a transmission of energy and/or force or torque from the stationary machine part to different moving machine parts, for example two rockers of a laboratory vibrating mill, several coupling devices can be provided, each with at least one coupling element, whereby a transmission of energy from the stationary machine part to two separate (kinematically decoupled) moving machine parts is provided via the coupling devices, in particular whereby the coupling devices are coupled to a common drive arranged on the stationary machine part for a transmission of energy from the stationary machine part to the moving machine part or can be coupled via a coupling device. Using the plurality of coupling devices, it is possible, for example, to use a motorized drive on the stationary machine part to transmit a clamping torque as required to two clamping devices of a vibrating mill that are arranged on different swing arms of the vibrating mill. Each coupling device can have a drive wheel arranged on the stationary machine part, which is coupled to the motor shaft of the motorized drive or can be coupled via a coupling device. A torque can be applied to both drive wheels via the motor shaft, whereby the torque is transmitted from the respective drive wheel to an output wheel on the moving machine part via a coupling element assigned to the drive wheel, for example a bead chain. For example, several bead chain drives can be realized in order to transmit a cable force or a clamping torque from a motor drive on the stationary machine part via two bead chains to output wheels, which are mounted on different moving machine parts and transmit the transmitted torque to a clamping device assigned to the respective moving machine part for clamping the grinding bowl on the respective machine part. It is particularly preferable for a force or torque to be transmitted via two bead chain drives from a motorized drive to two output wheels, which are arranged on different rockers of a laboratory vibrating mill. This makes it possible to realize automatic grinding bowl tensioning on two swing arms of a laboratory mill in a simple manner and with a compact design of the mill, preferably with just one motor drive.

This makes it possible to transmit energy and/or force or torque from the stationary machine part to an identical moving machine part with several coupling devices. In particular, two coupling devices can be provided, each with at least one coupling element, whereby energy transmission from the stationary machine part, in particular from a common drive arranged on the stationary machine part, is provided via each coupling device, furthermore in particular with a time delay, to a same moving machine part, in particular whereby energy transmission to a clamping device for automatic clamping of the grinding bowl can be provided via the first coupling device and energy transmission to a swiveling drive for automatic rotation of the grinding bowl can be provided via the second coupling device.

In particular, a first coupling element of a first coupling device can be used to transmit a clamping force or a clamping torque from the stationary machine part of the ball mill to a clamping device of a grinding bowl holder in order to effect the automatic grinding bowl clamping. A further coupling element of a further coupling device can then be used to transmit a drive force and/or a drive torque to a rotating device for rotating the grinding bowl, with the rotating device being set up in particular for rotation after controlled interruption of the grinding operation and at least partial release of the grinding bowl clamping.

With a plurality of coupling elements, it is possible to transmit forces or torques of different magnitudes from the stationary machine part to the same moving machine part or even to different moving machine parts in order to drive different devices, such as a clamping device and a rotating device of a grinding bowl holder.

Further aspects of the present invention relate to the transmission of hydraulic, pneumatic or electrical energy from the stationary machine part via corresponding coupling elements to a moving machine part of the laboratory mill.

For example, a compressor for providing a compressed fluid, in particular compressed air, or a hydraulic unit for providing a hydraulic fluid can be provided on the moving machine part. The coupling device is then connected to the compressor or the hydraulic unit on the drive side. A compressed fluid, in particular compressed air, can also be taken from a storage tank or pipeline network, for example a pressurized container that is installed in the vicinity of the laboratory mill and connected to the laboratory mill via a pressure line. Compressed fluid or hydraulic fluid is preferably generated outside the ball mill, which may have corresponding fluid connections to a pipe network for compressed fluid or hydraulic fluid or a compressor or a hydraulic unit or corresponding pressure vessels. Compressed air hoses or pressure lines or even rigid pipes can be used as coupling elements for energy transmission. To compensate for relative movements between moving machine parts and a stationary machine part, an elastic deformation of the coupling element can be provided and/or at least one rotary feed-through for a sealed transition can be provided.

On the output side, a pneumatic motor or hydraulic motor can be provided as part of the coupling device in order to convert hydraulic or pneumatic energy into mechanical work. By applying pressure to rotors or gear wheels, pneumatic or hydraulic energy can be converted into rotational energy so that the clamping forces and/or clamping torques required for clamping the grinding bowl can be generated on the output side. On the output side, the coupling device can comprise a force or energy converter in the form of a rotary vane or vane pump, whereby a rotary movement is generated by pressurizing a rotor or gearwheel with compressed gas or compressed air. Alternatively, a piston can be provided as a displacement element, which is displaced in translation by the pressurization with compressed gas or compressed air. This can be used to generate the clamping forces and clamping torques required for clamping the grinding bowl. A rotor, a gear wheel or a gear wheel arrangement or the adjusting piston can then co-operate with a clamping device on the moving machine part or also form part of the clamping device in order to generate the clamping forces and/or clamping torques required for automatic grinding bowl clamping.

In principle, it is also possible to transmit electrical energy from the stationary machine part to the moving machine part via a power line as a coupling element. For example, an actuator can be carried on the grinding bowl holder, which converts an electrical signal into mechanical movements to generate a drive torque and/or a drive force, for example as an electromechanical drive that drives a threaded spindle and/or moves a push rod of a clamping device and thus generates an axial clamping force. The actuator can be supplied with electrical power from the operating power supply of the laboratory mill.

The transmission of hydraulic, pneumatic or electrical energy from the stationary machine part via the coupling element to a moving machine part, in particular a grinding bowl holder, can be provided as an alternative or in addition to the mechanical transmission of kinetic energy via a coupling element. The energy transmitted with a corresponding coupling element can be provided in forces and/or torques for the grinding bowl clamping and/or for the grinding bowl rotation when the grinding bowl is held in and/or on the grinding bowl holder and the grinding bowl clamping is released.

### BRIEF DESCRIPTION OF THE DRAWINGS

The invention is explained below by way of example using a preferred embodiment. The drawing shows

FIG. 1 is a schematic partial view, partially sectioned, of a first embodiment of a vibrating mill according to the invention with a coupling device for transmitting energy from a stationary machine part to a moving machine part, with a bead chain drive for generating a clamping force for automatic grinding bowl tensioning.

FIG. 2 is a schematic partial view of the output side of a coupling device for transmitting energy from a stationary machine part to a moving machine part with a bead chain drive, wherein an output wheel for a bead chain of the bead chain drive is provided on the output side of the coupling device.

FIG. 3 is a schematic partial view of the drive side of a coupling device for transmitting energy from a stationary machine part to a moving machine part with a bead chain drive, wherein a drive wheel for a bead chain of the bead chain drive is provided on the drive side of the coupling device.

FIG. 4 is a schematic partial view of the output side of a coupling device for transmitting energy from a stationary machine part to a moving machine part with a bead chain drive, wherein a planetary gear with a ring gear is provided on the output side of the coupling device as an output wheel for a bead chain of the bead chain drive.

FIG. 5 is a partial perspective view of the vibrating mill from FIG. 1.

FIG. 6 is a partially exploded view of the vibrating mill from FIG. 1.

FIG. 7 is a schematic partial view, partially sectioned, of an alternative embodiment of a vibrating mill according to the invention with two coupling devices for transmitting force and/or torque to two clamping devices arranged on different swing arms of the vibrating mill.

FIG. 8 is a schematic partial view, partially sectioned, of a further alternative embodiment of a vibrating mill according to the invention with two coupling devices for transmitting force and/or torque to a tensioning device for tensioning the grinding bowl and to a rotary drive for rotating a grinding bowl, wherein the tensioning device and the rotary drive are realized on the same grinding bowl holder.

FIG. 9 is a partial perspective view of the vibrating mill shown in FIG. 8.

FIG. 10 is the vibrating mill shown in FIG. 9 after the insertion of a grinding bowl into a grinding bowl holder on a swing arm of the vibrating mill, whereby the clamping device and the rotary drive are shown partially cut out.

FIG. 11 is a schematic partial view of the design of a coupling device on the output side with a slip clutch to limit the possible torque transmission.

FIG. 12 is a partial perspective view of the output side of the coupling device from FIG. 11.

FIG. 13 is a replacement image of the output side with schematic representation of the gearbox circuit diagram.

### DETAILED DESCRIPTION

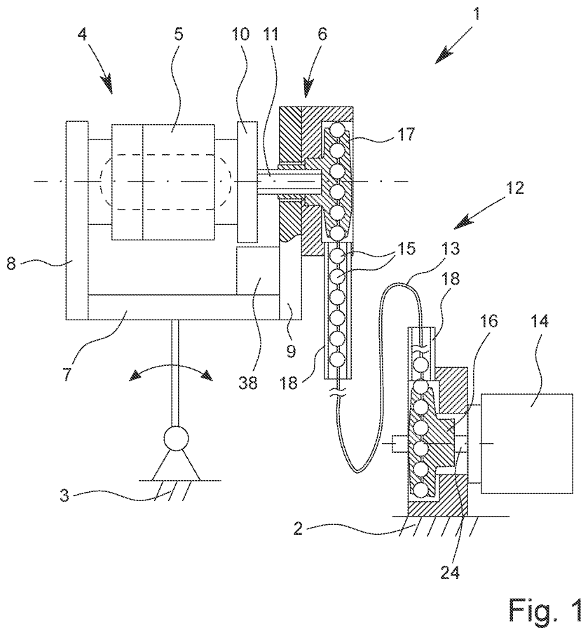

FIG. 1 shows a schematic partial view of a vibrating mill 1 with a stationary machine part 2 and with a machine part 3 that moves during the grinding operation of the vibrating mill. The moving machine part 3 is a swing arm of the vibrating mill 1, on which a grinding bowl holder 4 for at least one grinding bowl 5 is arranged. The vibrating mill 1 preferably has two rocker arms, whereby a grinding bowl holder 4 is arranged on each rocker arm. The fixed machine part 2 can be a base plate, a housing or a machine base frame of the vibrating mill 1, which is stationary during grinding operation and is fixed relative to the moving machine part 3 during grinding operation.

In the embodiment shown, the grinding bowl holder 4 has a base plate 7 with two holding legs 8, 9. A clamping device 6 for clamping the grinding bowl is also provided on the grinding bowl holder 4. The grinding bowl can be tensioned, for example, using a tensioning device which is described in DE 200 15 868 U1.

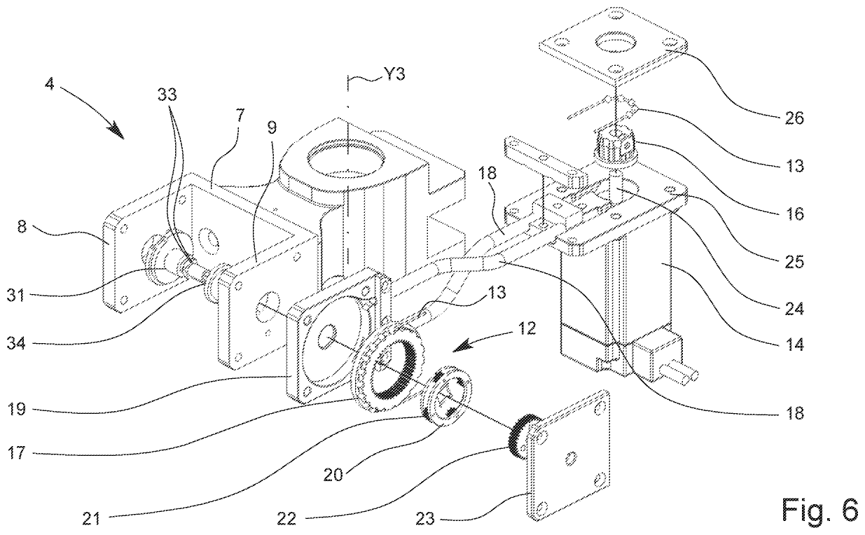

To transmit a clamping force to a grinding bowl 5, for example, a spindle drive with a thrust piece 10 shown schematically in FIG. 1 can be provided. The thrust piece 10 is non-rotatable and connected to a threaded bolt 11 shown schematically. The threaded bolt 11 is guided in a threaded nut 31 (FIG. 6) with an internal thread. At the end facing away from the grinding bowl 5, the threaded nut 31 has a coupling section 33 (FIG. 6) with a square geometry and is rotatably mounted in a collar bushing 34 (FIG. 6). Via the coupling section 33, the threaded nut 31 can be connected non-rotatably to a web wheel 20 (FIG. 6) of a planetary gear provided on the output side. As described in detail below, the transmission of a torque to the threaded nut 31 leads to an axial adjustment of the threaded bolt 11 relative to the threaded nut 31 and thus to the transmission of a clamping force to the grinding bowl 5 via the pressure piece 10.

As can also be seen from FIG. 1, an anti-rotation element 38 can be provided to prevent the thrust piece 10 from rotating.

As can also be seen from FIG. 1, a coupling device 12 with a coupling element 13 is provided for the mechanical transmission of force and/or torque from a motorized drive 14 arranged on the stationary machine part 2 to the moving machine part 3 or the rocker of the vibrating mill 1. In the embodiment shown, the coupling element 13 is a bead chain or ball chain, which has a plurality of equally spaced beads 15 or balls arranged on a core. On the drive side or motor side, the coupling device 12 has a drive wheel 16 and on the output side or on the side of the grinding bowl holder 4, an output wheel 17. The drive wheel 16 is connected to a motor shaft 24 for torque transmission (FIG. 6). The drive wheel 16 is kinematically coupled to the output wheel 17 via the bead chain. A torque transmitted via the bead chain to the output wheel 17 is converted via the spindle drive described above into an axial adjustment movement of the pressure piece 10 to generate the clamping force required for the grinding bowl clamping.

The wheels 16, 17 each have a fillet-shaped running surface bounded by lateral flanks, which contains recesses in the running base adapted to the beads 15 of the bead chain. This enables a safe and low-noise transmission of force or torque from the drive 14 to the tensioning device 6.

The design of the coupling device 12 as a bead chain drive allows a compact design of the vibrating mill 1 and a flexible arrangement of the drive 14 relative to the swing arm of the vibrating mill 1. The clamping torque or clamping force is generated decentrally, with the motor power being available at the grinding bowl holder 4. The multidimensional mobility of the bead chain allows the drive 14 to be arranged in a way that is adapted to the structural conditions inside the vibrating mill 1 relative to the rocker. This means that the available installation space inside the vibrating mill 1 can be optimally utilized for automatic grinding bowl tensioning.

The bead chain as a coupling element 13 can be guided in a hose 18, whereby the cable force is supported on the hose. The bead chain allows the hose to be bent in all directions. This allows relative movements between the stationary machine part 2 and the moving machine part 3 or the swing arm of the vibrating mill 1 to be equalized. The hose 18 can be made of PTFE or another lubricating plastic. Preferably, the hose 18 is slotted so that it is possible to thread the bead chain from the side. In addition, the tube 18 can be sheathed on the outside with a further tube, which is designed in particular as a C-tube. The additional tube protects the inner tube 18 from kinking and buckling. In particular, it prevents the inner tube 18 from collapsing in the event of high cable forces and the bead chain from being torn out of the inner tube 18 and the drive from getting stuck in the event of such a collapse of the inner tube 18.

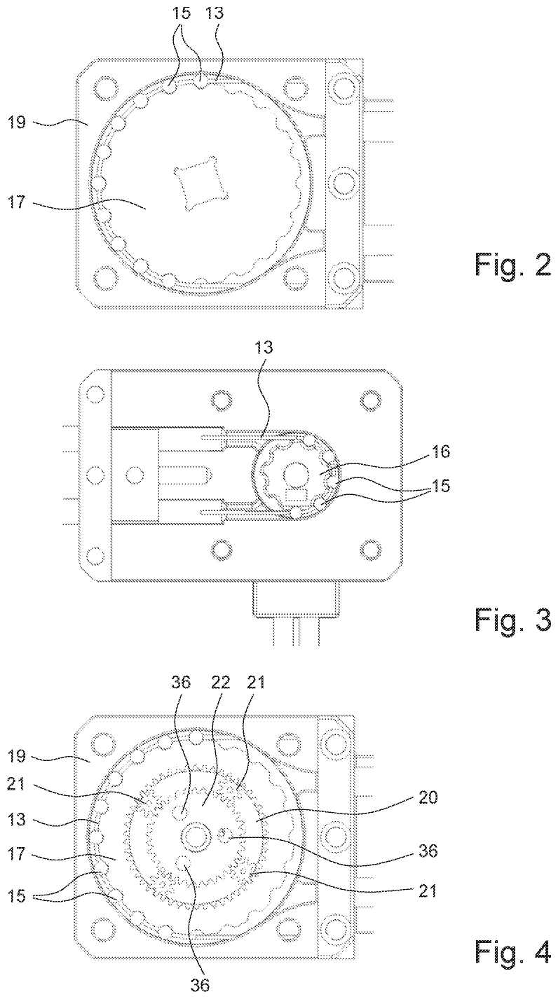

FIG. 6 shows the structure of the coupling device 12 on the output side. On the output side, a gear arrangement can be provided for torque conversion of the torque transmitted by the drive 14. According to FIG. 6 and FIG. 4, the gear arrangement can be designed as a single-stage planetary gear with, for example, four planetary gears 21 arranged on a spur gear 20 and a fixed sun gear 22, whereby the sun gear 22 interacts with the spur gear 20 and the output wheel 17 in order to generate a higher output torque. The output wheel 17 is designed as a ring gear of the planetary gear. An output housing 19 is provided to accommodate the output wheel 17. The sun gear 22 is non-rotatably connected to a housing cover 23 of the output housing 19, preferably with a positive fit. For this purpose, the sun gear 22 has several holes 36 (FIG. 4). The bore stanchions enable a positive fit: The housing has pins that are inserted into the bores of the sun gear 22. The transmission ratio of the planetary gear in a single-stage design can be between 1 and 2.5, for example 2.0. A multi-stage version of the planetary gear is also possible, whereby each stage can preferably have a transmission ratio of between 1 and 2.5.

The transmission of the bead chain drive can be self-locking, whereby the transmission can only be driven from one direction. Preferably, the spindle drive described above is self-locking to convert a torque into an axial clamping force on the one hand and the gearbox is self-locking on the other, so that even if the coupling element 13 is mechanically interrupted, for example if the bead chain breaks, there is no risk of the grinding bowl tensioning unintentionally releasing itself.

Alternatively, according to FIG. 2, a direct drive for the power transmission via the bead chain or the torque generation on the output side of the coupling device 12 and no gear arrangement can also be provided, whereby the cable force of the bead chain is transmitted to an output wheel 17 designed as a solid wheel. This results in a lower output torque with a less complex design.

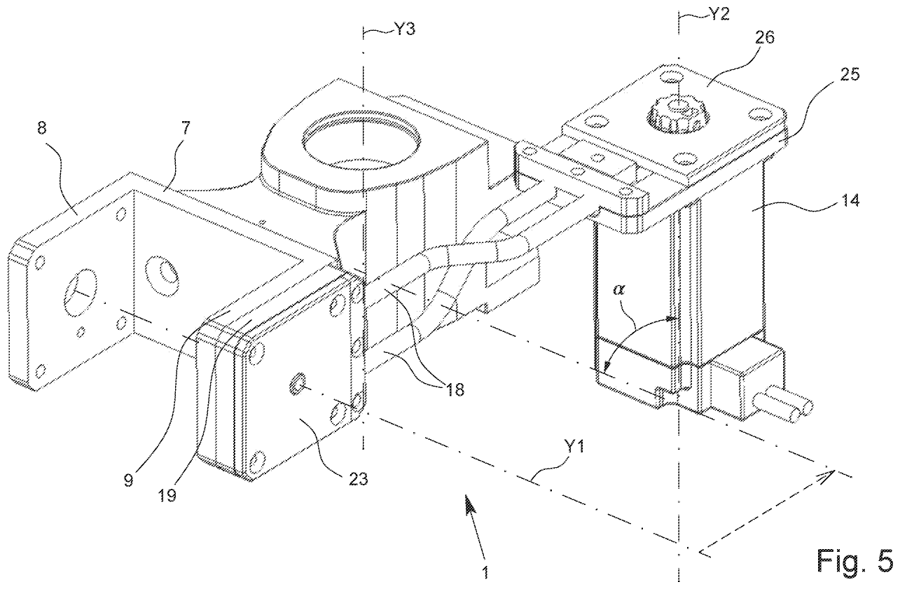

FIG. 3 and FIG. 6 show the drive side of the coupling device 12, whereby an electric drive 14 is provided on the drive side. The drive shaft 24 is connected to the drive wheel 16 through a recess in a base plate 25. A housing cover 26 forms the top end. Torque is transmitted from the drive shaft 24 to the drive wheel 24. The torque is transmitted to the output wheel 17 provided on the moving machine part 3 via the bead chain as coupling element 13. The transmission ratio between the output wheel 17 and the drive wheel 16 can be between 1 and 2.5, for example 2.0. FIG. 5 also shows the swing axis Y3.

FIG. 5 shows a detailed view of the vibrating mill 1 in the assembled state. As can be seen schematically from FIG. 5, the torque axes Y1, Y2 on the output side and on the drive side of the coupling device 12 can be arranged at any angle α to each other due to the flexibility of the bead chain drive with the circulating bead chain guided endlessly in the hoses 18.

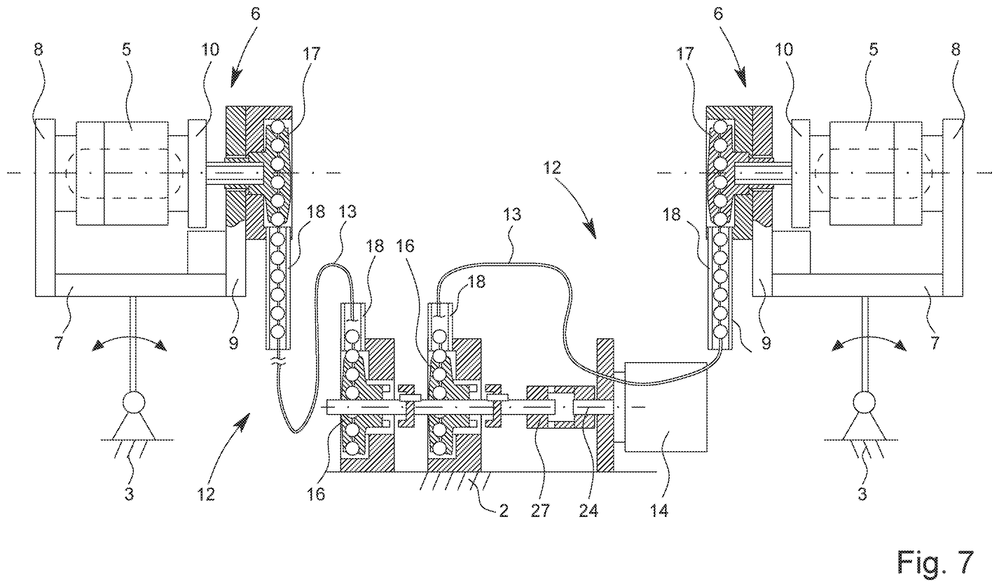

FIG. 7 shows an alternative embodiment of a vibrating mill 1 according to the invention in a schematic partial representation, wherein two essentially identically constructed coupling devices 12 of the type described in FIGS. 1 to 6 can be provided in order to realize a transmission of force and/or torque, preferably from a common motor drive 14, via a motor shaft 24 to the coupling devices 12 and from these to two clamping devices 6 on different rockers of the vibrating mill 1.

In addition, as shown schematically in FIG. 7, a switching element 27, for example a coupling device, can be provided in order to connect either the one coupling device 12 or the other coupling device 12 to the motor shaft 24 and thus, if necessary, to tension or release the tensioning devices 6 on the two rockers independently of one another and, for example, with a time delay.

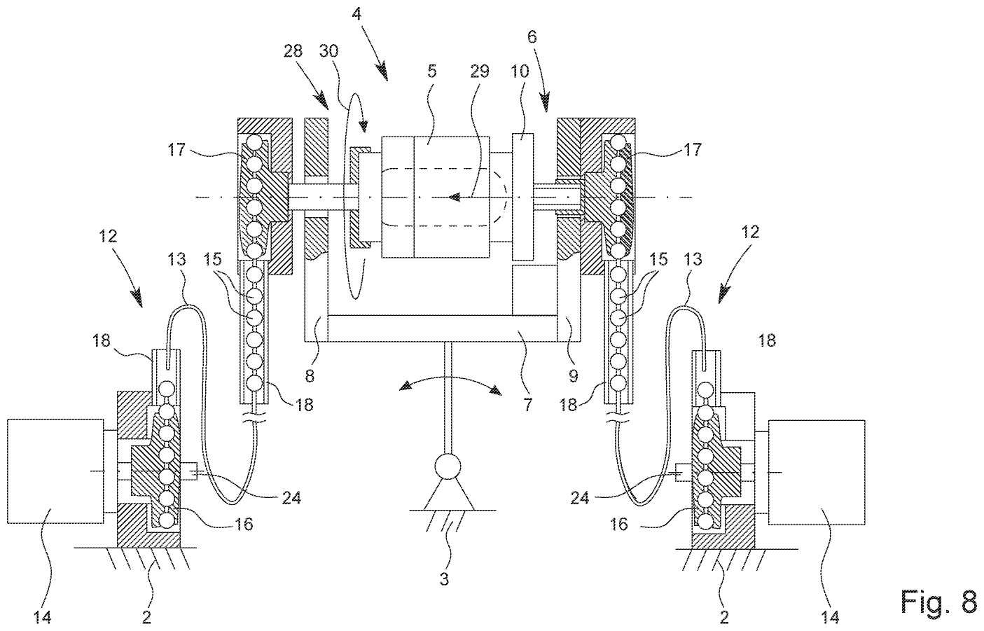

FIG. 8 schematically shows an arrangement in which several coupling devices 12 are provided for transmitting force or torque from a stationary machine part 2 to a moving machine part 3, in particular to a rocker of the laboratory vibrating mill 1. According to FIG. 8, two coupling devices 12 of the same design can be provided for force and/or torque transmission. Each coupling device 12 is connected via a coupling element 13 to a motorized drive 14 associated with the respective coupling element 13 and arranged on the stationary machine part 2. A first coupling device 12 is intended to transmit a force or a drive torque to a clamping device 6 in order to automatically clamp a grinding bowl 5 in a grinding bowl holder 4. A swivel or rotary drive 28 is provided on the opposite side of the grinding bowl holder 4, with which it is possible to rotate or swivel the grinding bowl 5 in the at least partially relaxed state for standardizing the grinding results by transmitting force and/or torque from the further drive 14 shown on the left in FIG. 8 and the further coupling device 12 also shown on the left in FIG. 8.

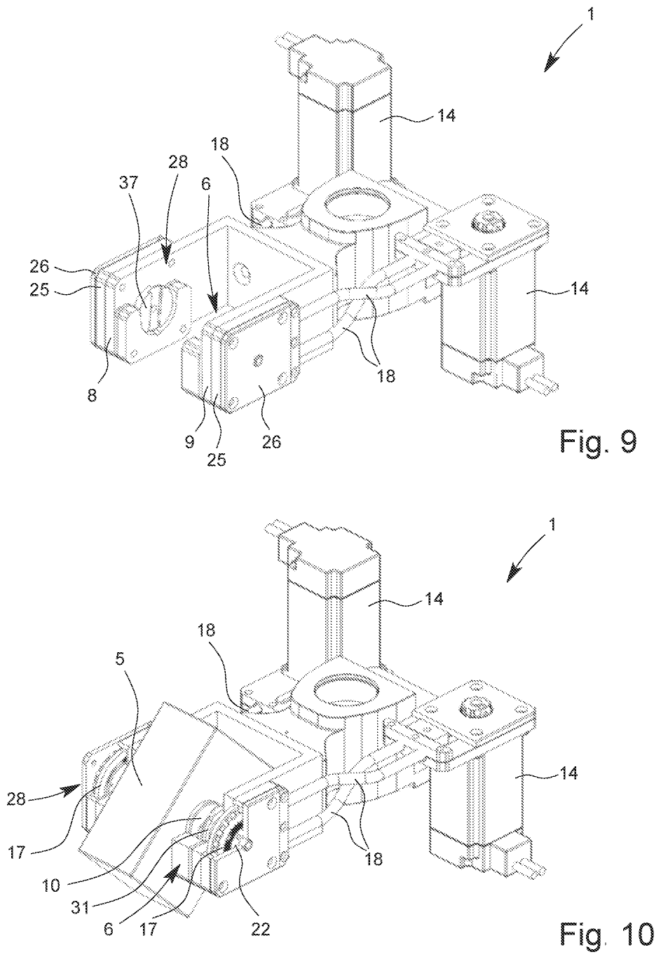

As can be seen in particular from FIG. 9, the rotating device 28 can have a rotating piece 37 that can be positively and/or non-positively connected to the grinding bowl 5 in order to rotate the grinding bowl 5 as required. The rotating piece 37 can have a coupling geometry or spanner flat on the end face facing the grinding bowl 5, which engages and/or couples positively with a complementary coupling geometry or spanner flat projection on the adjacent end face of the grinding bowl 5 when the grinding bowl 5 is inserted into the grinding bowl holder 4. The grinding bowl 5 can be swiveled by preferably 180° via the complementary surfaces and surface projections by turning the rotating piece 37.

A control and/or regulation system can be provided in such a way that a clamped grinding bowl 5 is automatically at least partially unclamped and then automatically rotated, for example after half the grinding time of a grinding process has elapsed. The rotated grinding bowl 5 is then automatically braced again and the grinding process is continued. The automatic grinding bowl tensioning and grinding bowl rotation effected by force and/or torque transmission from the stationary machine part 2 via two coupling devices 12 is shown schematically in FIG. 8 by the force arrow 29 and the torque arrow 30, whereby the arrow 29 indicates the direction of the tensioning force when tensioning the grinding bowl 5 in the grinding bowl holder 4 and the arrow 30 indicates a possible direction of rotation of the grinding bowl 5 to equalize the grinding results.

Not excluded is an embodiment in which the force and/or torque is transmitted to a clamping device 6 and a rotary drive 28 as described above by means of two coupling devices 12, wherein the two coupling devices 12 can be coupled to an identical motorized drive 14 via a coupling device or a switching element 27 as described in FIG. 7.

In FIGS. 9 and 10, the vibrating mill 1 of FIG. 8 is shown in a schematic view, whereby FIG. 9 shows the vibrating mill 1 before inserting a grinding bowl 5 into the grinding bowl holder 4 and FIG. 10 shows a grinding bowl 5 in a clamped and partially rotated state. As shown in FIGS. 9 and 10, the right-hand coupling device 12 can, for example, be provided for transmitting power from a first motorized drive 14 to a clamping device 6 and the left-hand coupling device 12 can be provided for transmitting power from a second motorized drive 14 to a rotary drive 28. The coupling devices 12 can have the same design. However, there may be design differences with regard to the torque transmission from the respective bead chain drive to the tensioning device 6 on the one hand and the rotary drive 28 on the other.

A direct drive is provided to transmit the cable force and generate torque on the side of the rotary drive 28, whereby the cable force is transmitted to an output wheel 17 designed as a solid wheel. Torque conversion via a gearbox is preferably not provided on the side of the rotary drive 28. The transmission of the cable force and torque generation on the side of the tensioning device 6, on the other hand, preferably takes place via a gear arrangement with a planetary gear of the type shown in FIG. 4.

The drive 14 and the coupling device 12 are able to build up large torques and the resulting (clamping) forces. Overload can be reliably prevented with the aid of a safety clutch, in particular in the form of a magnetic slip clutch. This applies in particular in the event that grinding bowls 5 of different lengths need to be clamped in the grinding bowl holder 4. A slipping clutch can protect the drive and driven wheels 16, 17 and the bead chain as coupling element 13 from excessive stress.

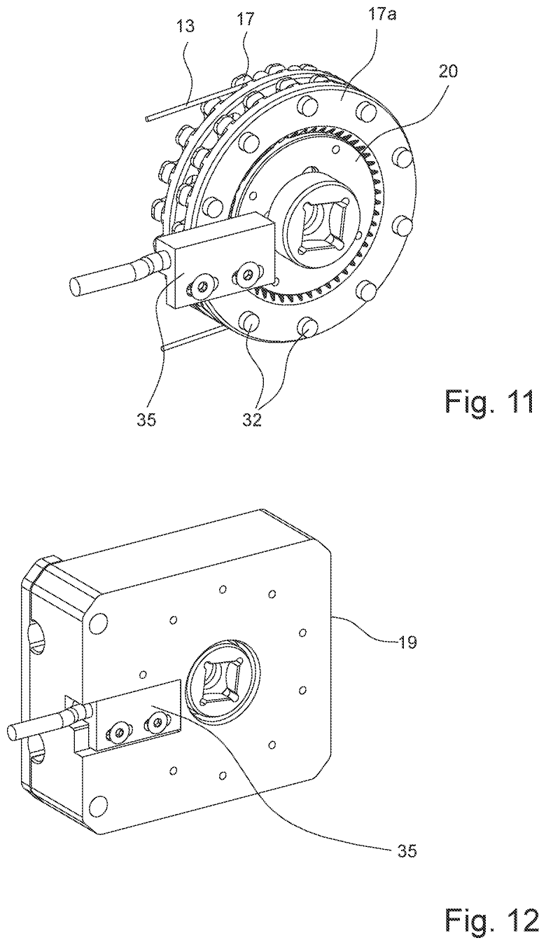

In the further FIG. 11 it is shown that the gear arrangement on the output side of the coupling device 12 can also have a multi-stage design, in particular as a multi-stage planetary gear. With a single-stage design, the transmission ratio of the planetary gear can be between 1 and 2.5, for example 2.0. In the case of a multi-stage design of the planetary gearbox, the transmission ratio per stage can be between 1 and 2.5, for example 2.0. This allows a higher output torque to be transmitted.

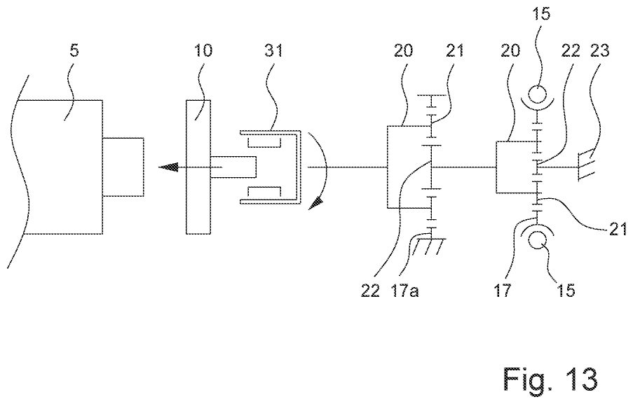

According to FIG. 13, the first gear stage is preferably formed by an output wheel 17, which is driven by the bead chain as coupling element 13 and is designed as a ring gear. The first output wheel 17 drives a spur gear 20 or a planet carrier. A sun gear 22 is firmly connected to a housing cover 23 and is therefore stationary. The spider 20 is connected to a further sun gear 22 of the second gear stage, which drives a further spur gear 20 of the second gear stage. A further ring gear 17a of the second gear stage is fixed. The torque transmission from the further spur gear 20 to the threaded nut 31 is also shown schematically. A rotational movement of the threaded nut 31 is converted into a translational movement of the thrust piece 10. The fixed ring gear 17a of the second gear stage is only stationary if the torque of a slipping element of the slipping clutch is not exceeded.

As can be seen from FIG. 11, on the end face of the further ring gear 17a of the second gear stage adjacent to the grinding bowl holder 4, for example, ten magnets 32 are inserted in pockets distributed around the circumference, which are provided in the further ring gear 17a with an end face. An adjacent output housing 19 (see FIG. 12) is also fitted with magnets, for example with four magnets, in order to generate a holding torque so that the additional ring gear 17a is held on the output housing 19 and remains stationary until an overload occurs. In the event of an overload, the additional ring gear 17a slips by at least one position and the magnetic field at a sensor 35 provided on the output housing 19 briefly breaks off. As soon as a signal break is detected, it is recognized that an overload has occurred. The sensor 35 can be a Hall sensor.

In particular, an overload case can be linked in terms of control and/or regulation with the reaching of an end position of the pressure piece 10. A control and/or regulation system with a corresponding control and/or regulation device can be provided, which evaluates the sensor signal of the sensor 35. In the case of a position-controlled and/or position-regulated drive 14, this makes it possible to link a signal break or the slipping of the slipping clutch detected by the sensor 35 with the reaching of a zero position or end position of a clamping means of the clamping device 6 and to provide this information for controlling and/or regulating the drive 14. If grinding bowls 5 with different grinding bowl lengths are to be used, it is possible to use the drive 14 to move or adjust the clamping means, for example the pressure piece 10 in the present case, in the direction of the grinding bowl 5 until a zero position or end position is detected by the slipping clutch slipping. This makes it possible to reference the drive 14 for a grinding bowl 5 with a specific grinding bowl length to the recognized zero position or end position. Depending on the end position or zero position detected for a specific grinding bowl length by the occurrence of the overload case, the drive 14 can then automatically move to the respective end position or zero position for all subsequent clamping operations until a new end position or zero position is reached when using grinding bowls 5 with a different grinding bowl length and is detected by the sensor 35 by a new signal break. This new end position or zero position then forms the reference position for all subsequent clamping operations. Control and/or regulation of the drive 14 is accordingly possible via the detection of an overload case when the grinding bowl clamping is opened, if a clamping means, for example the pressure piece 10 in the present case, is opened as far as possible when the grinding bowl clamping is released and strikes against a component. The impact can then cause the slipping clutch to slip and be detected as an overload.

A separating disc can be provided between the sensor 35 and the magnets 32, for example in the form of a sliding ring-shaped separating foil, which prevents the magnets 32 from coming loose from the receiving pockets in the output wheel 17 and then striking against the sensor 35 with a positive fit. The magnets 32 are held in the locating pockets by the separating disc and do not have to be glued in the pockets. The separating disc should be as thin as possible and abrasion-resistant. This results in the greatest possible magnetic force and a high torque of the slipping clutch.

### LIST OF REFERENCE SYMBOLS

1 Vibrating mill
2 Stationary machine part
3 Moving machine part
4 Grinding bowl holder
5 Grinding bowl
6 Clamping device
7 Base plate
8 Holding leg
9 Holding leg
10 Thrust piece
11 Threaded bolt
12 Coupling device
13 Coupling element
14 Motor drive
15 Pearl
16 Drive wheel
17 Output wheel
17a Ring gear
18 Hose
19 Output housing
20 Spur gear
21 Planetary gear
22 Sun wheel
23 Cover
24 Motor shaft
25 Base plate
26 Housing cover
27 Switching element
28 Rotary drive
29 Arrow
30 Arrow
31 Threaded nut
32 Magnet
33 Coupling section
34 Socket
35 Sensor
36 Hole
37 Turning piece
38 Anti-rotation element

1. A laboratory ball mill, in particular a vibrating mill, centrifugal ball mill or planetary ball mill, further in particular a planetary ball mill with a transmission ratio of 1:−1, the laboratory ball mill having:
at least one grinding bowl holder for at least one grinding bowl arranged on a machine part of the ball mill which is moved during the grinding operation of the ball mill;
a clamping device arranged on the moved machine part for transmitting a clamping force to the grinding bowl; and
a coupling device with at least one coupling element;
wherein an energy transmission from the stationary machine part to the moving machine part for generating the clamping force is provided via the coupling device; and
wherein the coupling element is coupled to the stationary machine part and to the moving machine part during the grinding operation.

2. The laboratory ball mill according to claim 1, wherein the coupling element can be moved in several dimensions at least in certain areas to compensate for relative movements between the stationary machine part and the moving machine part.

3. The laboratory ball mill according to claim 1, wherein kinetic energy can be transmitted via the coupling element from a motor drive arranged on the stationary machine part to the moving machine part.

4. The laboratory ball mill according to claim 1, wherein the coupling element is a traction means of a positive traction means drive.

5. The laboratory ball mill according to claim 1, wherein a chain of a chain drive is provided as the coupling element.

6. The laboratory ball mill according to claim 1, wherein the coupling element is integrated into a hose guide.

7. The laboratory ball mill according to claim 1, wherein the coupling device has a gear arrangement for torque conversion.

8. The laboratory ball mill according to claim 1, wherein the coupling device has an overload clutch.

9. The laboratory ball mill according to claim 8, further comprising:
a sensor device with at least one sensor for detecting a clutch separation in the event of an overload; and
a control and/or regulating device for controlling and/or regulating the drive as a function of a detected clutch separation.

10. The laboratory ball mill according to claim 1, further comprising at least two coupling devices each having at least one coupling element, wherein energy transmission from the stationary machine part to two different moving machine parts is provided via the coupling devices.

11. The laboratory ball mill according to claim 1, further comprising at least two coupling devices, each having at least one coupling element, energy being transmitted via the coupling devices from the stationary machine part to a moving machine part of the same type.

12. The laboratory ball mill according to claim 1, wherein hydraulic, pneumatic or electrical energy can be transmitted from the stationary machine part to the moving machine part via the coupling element.

13. The laboratory ball mill according to claim 5, wherein the chain is a multidimensionally movable chain.

14. The laboratory ball mill according to claim 13, wherein the multidimensionally movable chain is a ball chain.

15. The laboratory ball mill according to claim 7, wherein the gear arrangement for torque conversion is on the output side for torque increase.

16. The laboratory ball mill according to claim 8, wherein the overload clutch is a magnetic slip clutch.

17. The laboratory ball mill according to claim 10, wherein the coupling devices can be coupled to a common drive arranged on the stationary machine part for energy transmission from the stationary machine part to the moving machine part.

18. The laboratory ball mill according to claim 11, wherein energy is transmitted from a common drive arranged on the stationary machine part to the moving machine part.

19. The laboratory ball mill according to claim 18, wherein energy is transmitted from the stationary machine part to the moving machine part with a time delay.

20. The laboratory ball mill according to claim 11, wherein energy is transmitted to the clamping device via the first coupling device and energy is transmitted to a rotary drive via the second coupling device.
